(19) United States
(12) Patent Application Publication
(10) Pub. No.: US 2015/0349988 A1
(43) Pub. Date: Dec. 3, 2015

(54) SELECTING FLOATING TAP POSITIONS IN A FLOATING TAP EQUALIZER

(71) Applicant: LSI Corporation, San Jose, CA (US)

(72) Inventors: Viswanath Annampedu, Schnecksville, PA (US); Amaresh V. Malipatil, San Jose, CA (US)

(73) Assignee: LSI Corporation, San Jose, CA (US)

(21) Appl. No.: 14/291,909

(22) Filed: May 30, 2014

(51) Int. Cl. H04L 25/03

(52) U.S. Cl. CPC H04L 25/03878

(57) ABSTRACT

In one embodiment, an apparatus has an equalizer, a tap position locator, and a tap weight updater. The equalizer has a plurality of floating taps. The tap position locator generates metrics for a set of possible tap positions of the equalizer. Each possible tap position corresponds to a different tap weight, and the metrics are generated without updating the tap weights for all of the possible tap positions in the set. Further, the tap position locator selects a subset of possible tap positions from the set based on the metrics. The tap weight updater updates a subset of the tap weights corresponding to the selected subset of possible tap positions, and applies the updated subset of tap weights to the plurality of floating taps.

### BACKGROUND

1. Field of the Invention

The present invention relates to communications systems, and, more specifically but not exclusively, to equalizing signals in communications systems.

2. Description of the Related Art

When a pulse response of a communication channel spans multiple symbol periods, inter-symbol interference (ISI) results. Inter-symbol interference is a form of distortion of a received signal that occurs when one symbol of a transmitted signal interferes with subsequent symbols of the transmitted signal. Inter-symbol interference together with other noise may adversely affect the ability of a receiver to properly recover the transmitted symbols. Therefore, receivers are often implemented with equalizers, such as feed forward equalizers (FFE), decision feedback equalizers (DFE), and decision feed forward equalizers (DFFE), that reduce inter-symbol interference so that the transmitted symbols can be properly recovered.

Inter-symbol interference may be caused by reflections in a communications channel due to, for example, discontinuities in a transmission line of a wired channel or multipath fading in a wireless channel. These reflections often cause inter-symbol interference to affect a wide range of symbols. For example, a current symbol being detected at a receiver may be affected by inter-symbol interference from a symbol that was transmitted 45 symbol periods earlier. One method for accounting for inter-symbol interference in a wide range of symbols is to use an equalizer with a large number of taps, wherein the number of taps is equal to the number of symbols in the range of symbols. However, equalizers having large numbers of taps are impractical due to their complexity and the significant amount of power and area that they consume.

### SUMMARY

One embodiment of the disclosure is a method for configuring a plurality of floating taps in an equalizer. The method comprises generating metrics for a set of possible tap positions of the equalizer, and selecting a subset of possible tap positions from the set based on the metrics. Each possible tap position corresponds to a different tap weight, and the metrics are generated without updating the tap weights for all of the possible tap positions in the set. A subset of the tap weights corresponding to the selected subset of possible tap positions is updated, and the updated subset of tap weights is applied to the plurality of floating taps. Another embodiment of the disclosure is an apparatus for carrying out the above-mentioned method.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 shows a simplified block diagram of a receiver according to one embodiment of the disclosure;

FIG. 2 shows a simplified block diagram of a decision feedback equalizer according to one embodiment of the disclosure that may be used to implement the decision feedback equalizer in FIG. 1;

FIG. 3 shows a simplified block diagram of a tap position locator according to one embodiment of the disclosure that may be used to implement the tap position locator in FIG. 2;

FIG. 4 shows a simplified block diagram of a resettable accumulator according to one embodiment of the disclosure that may be used to implement each accumulator in FIG. 3;

FIG. 5 shows a simplified flow diagram of a method for operating an equalizer according to one embodiment of the disclosure; and

FIG. 6 shows a simplified block diagram of a receiver according to another embodiment of the disclosure.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Typically, in a wide range of symbols, reflections occur in only a relatively small subset of the symbols. Therefore, inter-symbol interference can be reduced at a receiver by cancelling inter-symbol interference at only those tap positions in the equalizer that correspond to the subset of symbols. To reduce the complexity of the equalizer, rather than implementing taps for the entire range of symbols, taps can be implemented for only a subset of symbols at the positions where inter-symbol interference is most significant. However, these positions can vary from one channel to the next, and they can vary within the same channel due to, for example, changes in temperature.

To account for the differing inter-symbol interference positions, a receiver may employ a floating-tap equalizer comprising a set of floating (i.e., selectively configurable) taps. In operation, the floating-tap equalizer evaluates a set of possible tap positions to identify a subset of the possible tap positions where inter-symbol interference is most significant. The identified subset of possible tap positions may vary from one channel to the next and even within the same channel. Then, the floating taps are configured to reduce inter-symbol interference in the received signal at the identified subset of possible tap positions, without reducing inter-symbol interference at any of the other possible tap positions. Note that, as used herein, the term “possible tap position” refers to a tap position that can be implemented by a floating-tap equalizer. However, the floating-tap equalizer is capable of implementing only a subset of the possible tap positions in a set at any given time.

U.S. Pat. No. 8,121,183 (“the '183 patent”), the details of all of which are incorporated herein by reference in their entirety, teaches a plurality of decision feedback equalizers that employ floating taps, and methods for identifying subsets of possible tap positions to be implemented by the floating taps. However, more-efficient methods are needed to identify the subsets of possible tap positions to be implemented by the floating taps.

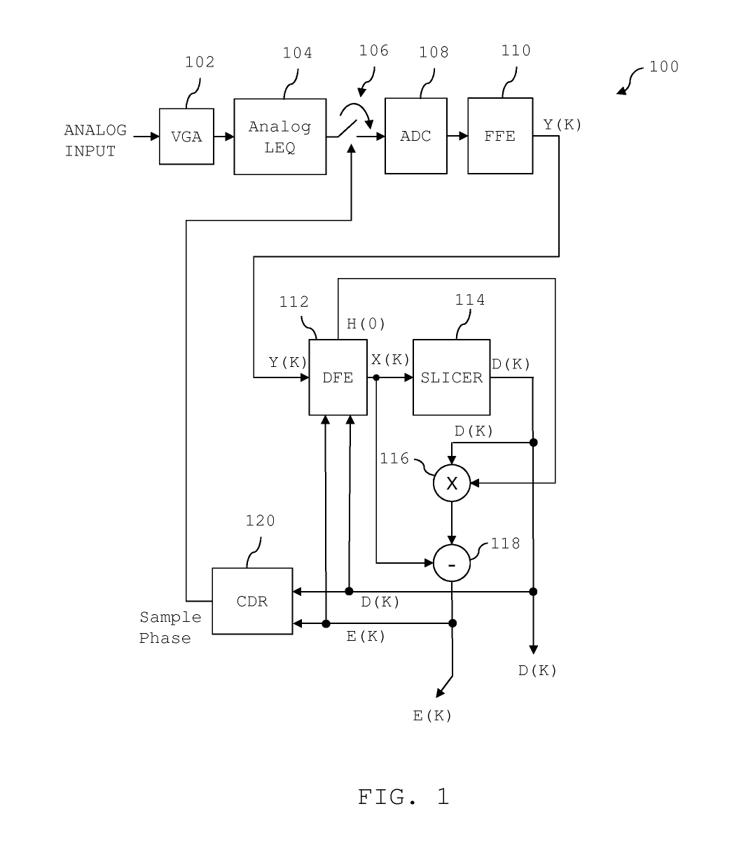

FIG. 1 shows a simplified block diagram of a receiver 100 according to one embodiment of the disclosure. Receiver 100 may be implemented in any suitable communications system, including wired and wireless communications systems. Further, receiver 100 may also be implemented in a read channel of a storage device such as (without limitation) the read channel of a hard-disk drive.

In operation, variable-gain amplifier (VGA) 102 of receiver 100 amplifies an analog input signal such that the analog input signal occupies a full dynamic range of analog-to-digital converter (ADC) 108. Signal shaping is applied to the resulting amplified analog signal by analog linear equalizer (LEQ) 104, and the amplified analog signal is converted from a continuous-time and continuous-amplitude analog signal to a discrete-time and discrete-amplitude digital signal by sampler 106 and analog-to-digital converter 108. Sampling of the analog signal is performed based on a sampling phase generated by clock and data recovery circuit 120.

The digital signal output from analog-to-digital converter 108 is equalized by feed forward equalizer (FFE) 110 to generate equalized signal Y(K), where K represents the index to a symbol. Each symbol may be generated at a transmitter (not shown) using any suitable modulation method such as (without limitation) pulse-amplitude modulation (PAM), quadrature-amplitude modulation (QAM), phase-shift keying (PSK), and transmitted to receiver 100 via a communications channel (not shown).

Decision feedback equalizer (DFE) 112, the details of which are described further below, generates an improved equalized signal X(K) by cancelling inter-symbol interference in the equalized signal Y(K) based on symbol decisions D(K) generated by slicer 114 and an error signal E(K). Decision feedback equalizer 112 is a mixed, fixed-tap and floating-tap equalizer, meaning that decision feedback equalizer 112 comprises Z fixed taps, where Z≧1, and N floating taps, where N≧1. In general, decision feedback equalizer 112 considers a whole set of M possible tap positions i, where i=1, 2, . . . , M. Some of the tap positions (i.e., Z) are always updated and used, and these tap positions are referred to as fixed taps. Of the remaining possible tap positions, only a subset of N possible tap positions is used. These tap positions may vary over time and are referred to as floating taps.

Decision feedback equalizer 112 identifies and selects the subset of N possible tap positions from the M possible tap positions for inter-symbol interference reduction as described in further detail below. Once the subset of N possible tap positions is identified, the N floating taps are configured to reduce inter-symbol interference in the equalized signal Y(K) at the identified N possible tap positions, and inter-symbol interference is reduced at both the Z fixed taps and the N floating taps.

The decisions D(K) generated by slicer 114 are provided to multiplier 116, where the decisions D(K) are multiplied by a target H(0) generated by decision feedback equalizer 112. The resulting product is subtracted from the equalized signal X(K) output by decision feedback equalizer 112 to generate an error signal E(K), which is fed, along with decisions D(K) to both clock and data recovery circuit 120 and decision feedback equalizer 112.

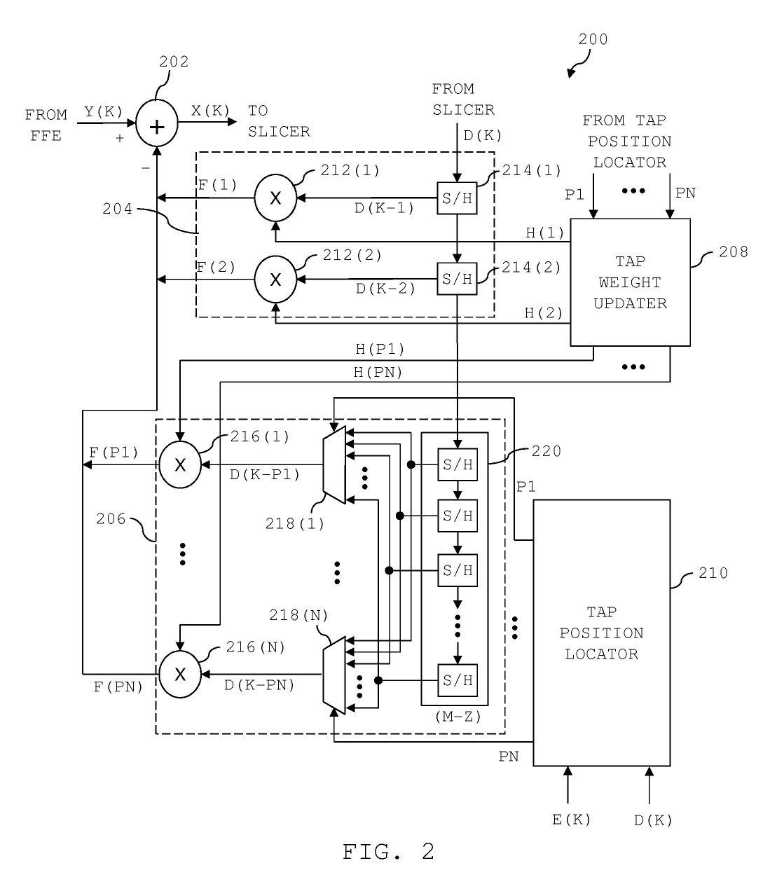

FIG. 2 shows a simplified block diagram of a decision feedback equalizer 200 according to one embodiment of the disclosure that may be used to implement decision feedback equalizer 112 of FIG. 1. Decision feedback equalizer 200 comprises an adder 202, a fixed tap block 204, and a floating tap block 206 that operate in manners similar to those of the analogous components shown in FIG. 2 of the '183 patent. In addition, decision feedback equalizer 200 comprises a tap weight updater 208 and a tap position locator 210, the details of both of which are described further below.

Fixed tap block 204 comprises Z=2 fixed taps z, where each fixed tap z comprises a sample- and-hold block 214(z) and a multiplier 212(z) and z=1, . . . , Z. Note that, in this embodiment, the fixed tap positions are the first and second possible tap positions (i.e., i=1 and 2), respectively, of the set of M possible tap positions that can be implemented by decision feedback equalizer 200. In alternative embodiments, the fixed tap positions might be positions other than i=1 and 2, including non-consecutive positions with one or more floating tap positions there-between. Further, Z may be equal to one or greater than 2. Floating tap block 206 comprises N floating taps n, n=1, 2, . . . , N, where each floating tap n comprises a multiplexer 218(n) and a multiplier 216(n).

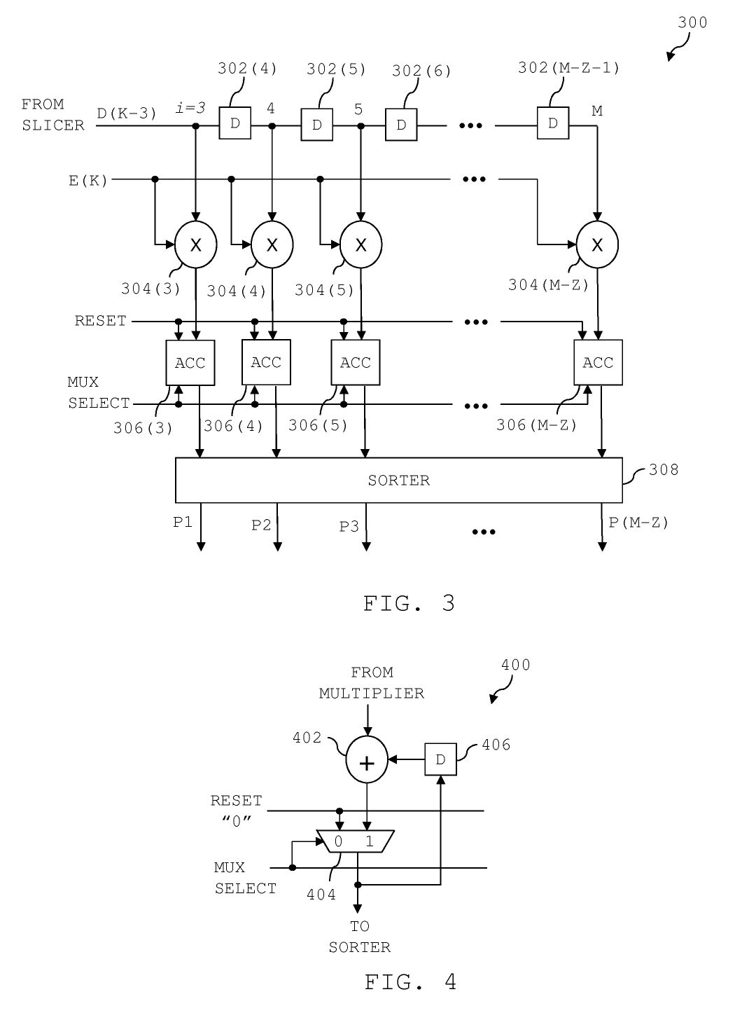

In general, tap position locator 210 identifies a subset of N possible tap positions Pn for inter-symbol interference reduction as described in further detail below in relation to FIGS. 3-5. The subset of N possible tap positions Pn is identified from the set of M possible tap positions i that can be implemented by decision feedback equalizer 200 (although not all at once), excluding the Z fixed tap positions. Thus, in this embodiment, the subset of N possible tap positions may be selected from possible tap positions i=3, 4, . . . , M that can be implemented by decision feedback equalizer 200.

Once the possible tap positions Pn are found, the operation of the fixed taps and floating taps is as follows. For each fixed tap, the corresponding sample-and-hold block 214(z) delays a decision D(K) received from the slicer, and the corresponding multiplier 212(z) multiplies the delayed decision D(K-z) by a tap weight H(z) received from tap weight updater 208 to generate a cancellation signal F(z).

For each floating tap, the corresponding multiplexer 218(n) (i) receives M delayed decisions D(K) from a sample-and-hold register 220 and (ii) outputs one of the delayed decisions D(K) based on a possible tap position Pn received at a control port of the multiplexer 218(n) from tap position locator 210. The delayed decision D(K) output by the multiplexer 218(n) corresponds to the possible tap position Pn identified by tap position locator 210.

The multiplier 216(n) of the floating tap multiplies the delayed decision D(K) output by the multiplexer 218(n) by a tap weight H(Pn) that corresponds to the possible tap position Pn identified by tap position locator 210 to generate a cancellation signal F(Pn). Thus, each floating tap is selectively configured to reduce inter-symbol interference at an identified tap position Pn by providing (i) the tap position Pn to the control port of the multiplexer 218(n) and (ii) the tap weight H(Pn) to the multiplier 216(n).

Each cancellation signal F(z) and F(Pn) is provided to adder 202 where they are subtracted from the equalized signal Y(K) received from the feed forward equalizer to generate the improved equalized signal X(K) that is provided to the slicer. Subtracting cancellation signals F(z) and F(Pn) from the equalized signal Y(K) reduces inter-symbol interference in equalized signal Y(K) corresponding to fixed tap positions 1 and 2 and floating tap positions P1 to PN.

FIG. 3 shows a simplified block diagram of a tap position locator 300 according to one embodiment of the disclosure that may be used to implement tap position locator 210 in FIG. 2. In general, tap position locator 300 generates a metric for each possible tap position i in a set of M different possible tap positions, excluding the Z fixed tap positions (e.g., i=1 and 2), and sorts the metrics from largest to smallest to identify a subset of N possible tap positions Pn having the largest metrics. The subset of N tap positions Pn may then be used in an equalizer such as decision feedback equalizer 200 of FIG. 2 for inter-symbol interference reduction.

Tap position locator 300 comprises a tapped-delay line that comprises delay elements 302(4) to 302(M-Z-1), each of which delays a decision D(K) generated by the slicer. Each possible tap position i comprises a multiplier 304(i), an accumulator (ACC) 306(i), and, with the exception of the first tap position i, a delay element 302(i) of the tapped-delay line.

In operation, tap position locator 300 correlates the decisions D(K) with the error signal E(K). Specifically, during each symbol period, each multiplier 304(i) multiplies a delayed decision D(K) (or a current decision D(K) in the case of multiplier 304(3)) by a current error estimate E(K). The resulting product is accumulated in the corresponding accumulator 306(i) with products generated during previous symbol periods. As the duration of accumulations increases, the accuracy of the accumulations also increases. However, more-complex accumulation circuits are needed to accommodate larger numbers of accumulations. Therefore, to avoid using complex accumulation circuits, the accumulators 306(i) may be reset upon the expiration of a specified number of symbol periods (e.g., 8,192 symbol periods).

When the specified number of symbol periods has elapsed, sorter 308 sorts the resulting metrics (i.e., accumulation values) from the accumulators 306(3) to 306(M-Z) from largest to smallest, with P1 corresponding to the largest accumulation value and P(M-Z) corresponding to the smallest accumulation value. Note that the possible tap position i for each accumulation value is retained with the accumulation value. A subset of N possible tap positions P1, P2, . . . , PN having the largest accumulation values is then selected from the set of P(M-Z) possible tap positions.

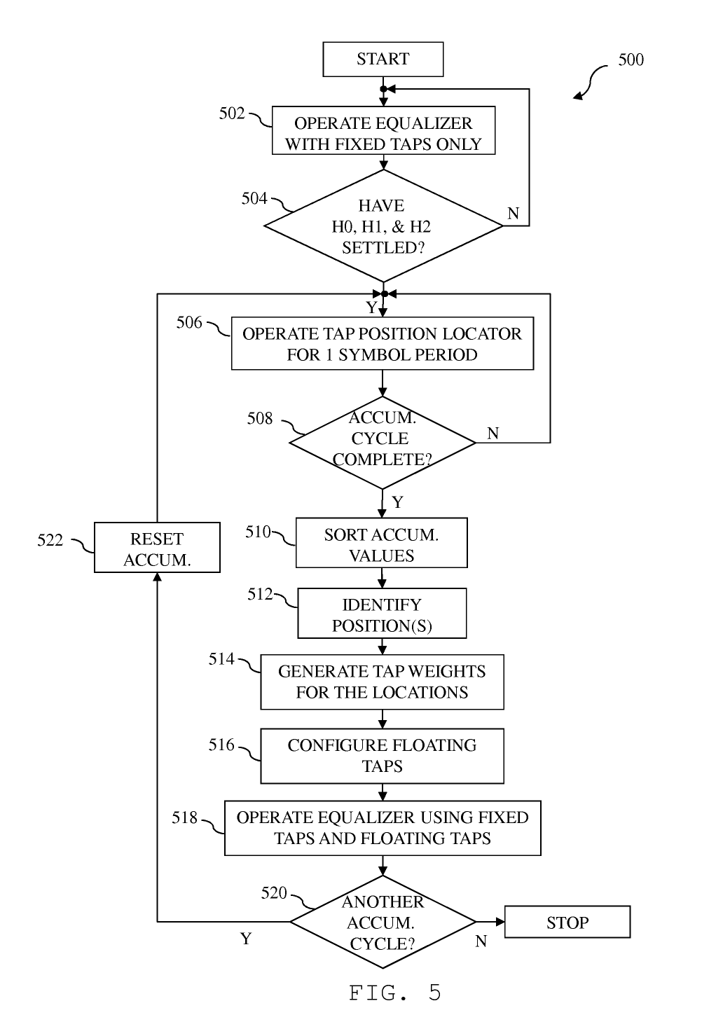

FIG. 4 shows a simplified block diagram of a resettable accumulator 400 according to one embodiment of the disclosure that may be used to implement each accumulator 306(i) in FIG. 3. During each symbol period, except for the first, adder 402 of resettable accumulator 400 adds a product from a corresponding multiplier 304(i) with an accumulation value generated during a previous symbol period that is delayed by delay element 406. The new accumulation value is output by multiplexer 404 to delay element 406 based on a MUX SELECT signal that is set to one. When the specified number of symbol periods has elapsed, the MUX SELECT signal is set to zero, and the multiplexer 404 outputs the reset value of zero to delay element 406, thereby resetting the accumulation value.

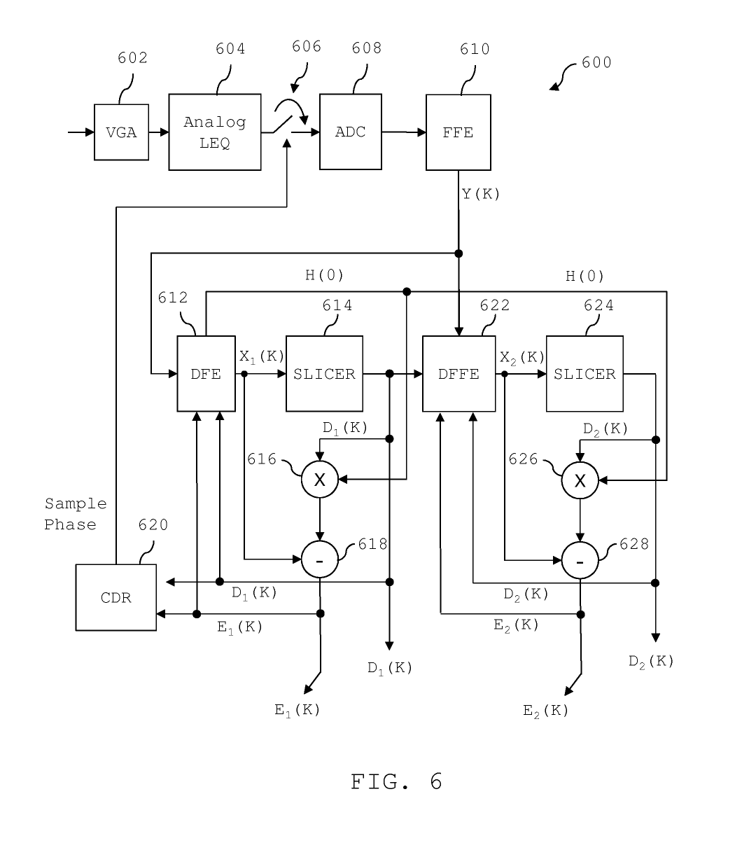

FIG. 5 shows a simplified flow diagram of a method 500 for operating an equalizer according to one embodiment of the disclosure. For ease of discussion, FIG. 5 is described relative to its use with decision feedback equalizer 200 of FIG. 2 and tap position locator 300 of FIG. 3; however, it will be understood that method 500 can be used with other equalizers, including decision feed forward equalizers, and other tap position locators of the present disclosure.

Initially, in step 502, decision feedback equalizer 200 is operated using only fixed tap block 204 of FIG. 2. Typically, the first two tap positions will have significant inter-symbol interference, and therefore, these two positions are fixed. During the initial operation of fixed tap block 204, tap weight updater 208 adapts a target H(0) (not shown) and the tap weights H(1) and H(2) for the first two tap positions. The tap weights may be adapted using any suitable algorithm, including (without limitation) a least-mean squares (LMS) algorithm. Once the target H(0) and tap weights H(1) and H(2) have settled (step 504) (e.g., a running average of each tap weight remains relatively stable over a specified number of symbol periods or each tap weight changes by less than a threshold amount over a specified number of symbol periods), the error signal E(K) should be relatively reliable for use in finding the subset of N possible tap positions Pn for inter-symbol interference reduction. Although not shown, the fixed taps can continue to be used during the performance of steps 506 to 522.

In step 506, tap position locator 300 of FIG. 3 is operated for one symbol period to update the accumulated values of accumulators 306(i). Step 506 is repeated for subsequent symbol periods until a specified number of symbol periods has elapsed (step 508). At such time, one “accumulation cycle” has been completed. Sorter 308 sorts the (M-Z) accumulation values of the last symbol period from highest to lowest (step 510) and the tap position locator 300 identifies the subset of N possible tap positions P1 to PN having the largest accumulation values (step 512).

In step 514, the tap weight updater 208 of FIG. 2 updates tap weights H(P1) to H(PN) for positions P1 to PN, without updating the tap weights for the remaining taps in the set of (M-Z) possible tap positions. In at least one embodiment of the disclosure, tap weight updater 208 updates tap weights H(P1) to H(PN) by adapting the tap weights using a suitable tap weight adaptation algorithm such as (without limitation) a least mean squares algorithm.

In alternative embodiments of the disclosure, tap weight updater 208 updates tap weights H(P1) to H(PN) by (i) adapting one tap weight H(Pn) (e.g., the tap weight H(P1) corresponding to the largest accumulation value) using a suitable tap weight adaptation algorithm and (ii) calculating tap weights H(P2) to H(PN) based on the value of the adapted tap weight H(Pn). For example, tap weight updater 208 may calculate the tap weight H(Pn) for each tap position Pn by (i) calculating a ratio of the accumulation value for the tap position Pn to the accumulation value for the tap position P1, and (ii) multiplying the adapted tap weight H(P1) by the resulting ratio to generate the tap weight H(Pn).

Upon calculating updating tap weights H(P1) to H(PN), the floating taps of the floating tap block 206 are configured in step 516 by passing (i) each tap location P1 to PN to the control port of a corresponding multiplexer 218(n) and (ii) each updated tap weight H(P1) to H(PN) to a corresponding multiplier 216(n). The equalizer is then operated using the fixed taps and floating taps in step 518. If another accumulation cycle is to be performed (step 520), then accumulators 306(i) are reset in step 522 as described above and processing returns to step 506.

Once tap positions P1 to PN are identified, the floating taps may be configured to cancel inter-symbol interference using the identified tap positions. Initially, the tap weights H(Pn) may be set to zero, such that the floating taps do not provide any cancellation. Note that they also do not adversely affect the cancellation that is performed by the fixed taps. As the tap weights H(Pn) adapt, the quality of the equalized signal X(K) improves.

Although tap position locator 300 of FIG. 3 was described relative to its use with a specific decision feedback equalizer (e.g., 200 of FIG. 2), embodiments of the disclosure are not so limited. Tap position locator 300 may be used with other equalizers that employ floating taps, including other decision feedback equalizers and/or decision feed forward equalizers. As an example, consider FIG. 6.

FIG. 6 shows a simplified block diagram of a receiver 600 according to another embodiment of the disclosure. Receiver 600 has components 602 to 620 that operate in a manner analogous that of components 102 to 120 of FIG. 1 to generate decisions D₁(K) and error signal E₁(K). Note that decision feedback equalizer 612 may be implemented with or without tap position locator 300 of FIG. 3. In addition, receiver 600 has decision feed forward equalizer (DFFE) 622, slicer 624, multiplier 626, and adder 628.

Decision feed forward equalizer 622 reduces inter-symbol interference in symbols Y(K) received from feed forward equalizer 610 to generate an improved equalized signal X₂(K), which should be improved over equalized signal X₁(K). Like decision feedback equalizer 200 of FIG. 2, decision feed forward equalizer 610 comprises one or more fixed taps and one or more floating taps (neither of which are shown). In addition, decision feedback equalizer 612 and decision feed forward equalizer 622 may each have its own tap position locator or they may share a tap position locator.

In the former case, the tap position locator of decision feed forward equalizer 622 may be implemented in a manner similar to that shown in FIG. 3, and decision feed forward equalizer 622 may be operated in a manner similar that of method 500 shown in FIG. 5. Note, however, that the tap position locator of decision feed forward equalizer 622 will correlate improved decisions D₂(K) generated by slicer 624 with an improved error signal E₂(K) generated by multiplier 626 and adder 628, rather than the decisions D₁(K) generated by slicer 614 and error signal E₁(K) generated by multiplier 616 and adder 618. In the latter case, the tap position locator for decision feedback equalizer 612 may provide the subset of N tap positions to decision feed forward equalizer 622.

In some embodiments of the disclosure, decision feedback equalizer 612 may implement fixed taps, and not floating taps, and decision feed forward equalizer 622 may implement floating taps and the fixed taps. In such embodiments, the decision feedback equalizer 612 cancels inter-symbol interference at the fixed taps, and decision feed forward equalizer 622 cancels inter-symbol interference at both the fixed taps and the floating taps. As a result, the decisions D₂(K) and error signal E₂(K) may be improved over the decisions D₁(K) and error signal E₁(K). Further, in such embodiments, the floating tap positions may be performed based on improved decisions D₂(K) and improved error signal E₂(K).

Embodiments of the disclosure enable the positions of the N floating taps in a floating tap equalizer to be identified, and the floating taps to be configured, without adapting the tap weights of all M possible tap positions. As a result, significant computation resources can be saved when compared to comparable devices that require all M possible tap positions to be adapted before the N floating tap positions are identified. In addition, embodiments of the disclosure are capable of identifying the N floating tap positions quicker than comparable devices that require all M possible tap positions to be adapted before the N floating tap positions are identified.

According to an alternative embodiment of the disclosure, an equalizer may employ averaging to improve the accuracy of the tap position identification. For example, for each tap position, the accumulation value from one accumulation cycle may be averaged with the accumulation value from one or more other accumulation cycles. Then, sorter 308 may sort the averaged accumulation values for the (M-Z) possible tap positions, and the N tap positions with the largest averaged accumulations values may be selected.

As another example, the sorted results of multiple accumulation cycles may be compared to see if the same subset of floating tap locations is selected. After the same subset of floating tap locations is selected for multiple accumulation cycles, the subset is used.

According to another embodiment of the disclosure, a tap position locator (e.g., 300 of FIG. 3) may use only the signs of the decisions D(K) and/or the signs of error signal estimates E(K) in correlating the decisions D(K) with the error signal estimates E(K) to simplify the circuit.

Although embodiments of the disclosure were described relative to their use with digital signals and digital equalizers, embodiment of the disclosure are not so limited. It will be understood that alternative embodiments of the disclosure may also be implemented in analog equalizers to reduce inter-symbol interference in analog signals.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

Embodiments of the disclosure may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

Embodiments of the disclosure can be embodied in the form of methods and apparatuses for practicing those methods. Embodiments of the disclosure can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. Embodiments of the disclosure can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the disclosure.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

1. A method for configuring a plurality of floating taps in an equalizer, the method comprising:
(a) generating metrics for a set of possible floating tap positions of the equalizer, wherein:
each possible floating tap position corresponds to a different tap weight; and
the metrics are generated without updating the tap weights for all of the possible floating tap positions in the set;
(b) selecting a subset of possible floating tap positions from the set based on the metrics;
(c) updating a subset of the tap weights corresponding to the selected subset of possible floating tap positions; and
(d) applying the updated subset of tap weights to the plurality of floating taps.

2. The method of claim 1, wherein generating each metric in step (a) comprises:
(a1) correlating, for a possible floating tap position in the set of possible floating tap positions, decision symbols with error estimates to generate a plurality of products for the possible floating tap position; and
(a2) generating the metric for the possible floating tap position by accumulating the products for the possible floating tap position.

3. The method of claim 1, wherein step (b) comprises selecting at least one possible floating tap position for the subset of possible floating tap positions based on the at least one possible floating tap position having a metric that is larger than the metric of each possible floating tap position not in the subset of possible floating positions.

4. The method of claim 3, wherein step (b) comprises selecting each possible floating tap position for the subset of possible floating tap positions based on the possible floating tap position having a metric that is larger than the metric of each possible floating tap position not in the subset of possible floating tap positions.

5. The method of claim 1, wherein step (c) comprises:
(c1) adapting a first tap weight in the subset of tap weights for a first possible floating tap position; and
(c2) calculating one or more other tap weights in the subset of tap weights for one or more other possible floating tap positions based on the first tap weight.

6. The method of claim 5, wherein step (c2) comprises calculating each of the one or more other tap weights in the subset of tap weights based on the first tap weight and a ratio of (i) a metric for the first possible tap position and (ii) a metric for another possible tap position.

7. The method of claim 1, wherein step (c) comprises adapting all of the tap weights in the subset of tap weights.

8. The method of claim 1, wherein step (c) comprises updating the subset of tap weights, without updating all of the tap weights for all of the possible floating tap positions in the set.

9. The method of claim 1, wherein the method comprises, before step (a):
(1) equalizing an input signal based on a set of one or more fixed taps; and
(2) adapting tap weights corresponding to the set of one or more fixed taps.

10. An apparatus comprising:
an equalizer comprising a plurality of floating taps;
a floating-tap position locator configured to (i) generate metrics for a set of possible floating tap positions of the equalizer and (ii) select a subset of possible floating tap positions from the set based on the metrics, wherein:
each possible floating tap position corresponds to a different tap weight; and
the metrics are generated without updating the tap weights for all of the possible floating tap positions in the set; and
a tap weight updater configured to (i) update a subset of the tap weights corresponding to the selected subset of possible floating tap positions and (ii) apply the updated subset of tap weights to the plurality of floating taps.

11. The apparatus of claim 10, wherein the floating-tap position locator comprises:
a tapped-delay line configured to correlate decision symbols with error estimates to generate a plurality of products for a plurality of possible floating tap positions in the set of possible floating tap positions; and
one or more accumulators configured to generate each metric for a possible floating tap position in the set by accumulating the products for the possible floating tap position.

12. The apparatus of claim 10, wherein the floating-tap position locator is configured to select at least one possible floating tap position for the subset of possible floating tap positions based on the at least one possible floating tap position having a metric that is larger than a metric of each possible floating tap position not in the subset of possible floating tap positions.

13. The apparatus of claim 12, wherein the floating-tap position locator is configured to select each possible floating tap position for the subset of possible floating tap positions based on the possible floating tap position having a metric that is larger than the metric of each possible floating tap position not in the subset of possible floating tap positions.

14. The apparatus of claim 10, wherein the tap weight updater is configured to:
adapt a first tap weight in the subset of tap weights for a first possible floating tap position; and
calculate one or more other tap weights in the subset of tap weights for one or more other possible floating tap positions based on the first tap weight.

15. The apparatus of claim 14, wherein the tap weight updater is configured to calculate each of the one or more other tap weights in the subset of tap weights based on the first tap weight and a ratio of (i) a metric for the first possible tap position and (ii) a metric for another possible tap position.

16. The apparatus of claim 10, wherein the tap weight updater is configured to adapt all of the tap weights in the subset of tap weights.

17. The apparatus of claim 10, wherein the tap weight updater is configured to update the subset of tap weights, without updating all of the tap weights for all of the possible floating tap positions in the set.

18. The apparatus of claim 10, wherein:
the apparatus further comprises a set of one or more fixed taps; and
the tap weight updater is configured to adapt tap weights corresponding to the set of one or more fixed taps before the floating-tap position locator generates the metrics.

19. The apparatus of claim 18, wherein the equalizer is a decision feedback equalizer comprising the plurality of floating taps and the set of one or more fixed taps.

20. The apparatus of claim 10, wherein the equalizer is a decision feed forward equalizer.
